(19) United States
(12) Patent Application Publication
(10) Pub. No.: US 2014/0019612 A1
(43) Pub. Date: Jan. 16, 2014

(54) CENTRALIZED MULTI-TENANT MONITORING SYSTEM

(71) Applicants: Rolf Schimpfky, Dresden (DE); Mario Mueller, Pirna (DE); Thomas Dubiel, Moritzburg (DE); Heiko Braumann, Dresden (DE); Andre Walter, Dresden (DE)

(72) Inventors: Rolf Schimpfky, Dresden (DE); Mario Mueller, Pirna (DE); Thomas Dubiel, Moritzburg (DE); Heiko Braumann, Dresden (DE); Andre Walter, Dresden (DE)

(73) Assignee: SAP AG, Walldorf (DE)

(21) Appl. No.: 13/547,654

(22) Filed: Jul. 12, 2012

(51) Int. Cl. G06F 15/173

(52) U.S. Cl. 709/224

(57) ABSTRACT

Embodiments of the present invention provide a central monitoring system for enterprise resource planning software hosted in a plurality of customer tenants. The central monitoring system may include software instructions that when executed by a computer processor, performs a method include extracting process status data from one or more customer tenants independently, transforming the extracted process status data to generate generalized status codes according to predetermined status codes, transferring the generated generalized status codes to a central monitoring system, loading the generated generalized status codes to the central monitoring system, and transforming the generalized status codes to monitoring-specific simplified status codes.

### BACKGROUND

Server virtualization techniques allow a software service provider to operate multiple virtual machines (VM) on the same physical hardware (e.g., different VMs for different customer, and/or different VMs for different requests from same customer). With cloud computing gaining popularity in providing information technology (IT) services, instead of running and maintaining their own computer systems, a lot of customers turn to service providers. For example, a service provider typically hosts an enterprise resource planning (“ERP”) software package on multiple virtual machines (or “customer tenants” as referred herein) for one or more customers.

Traditionally, the ERP software status of each customer tenant is monitored individually by a service consultant of the software service provider. Individual monitoring increases the complexity and cost of the monitoring services provided by the software service provider. Individual monitoring also limits the software service provider's ability to actively measure, in aggregate, usage metrics for the ERP software applications across multiple customer tenants using the ERP software package. This hinders the software service provider's ability to identify potential early-stage problems within the ERP applications (e.g., application problems experienced by only a few tenants), which, in turn, increases response time of the software developer to rectify the early-stage problems before they are manifested across all customer tenants using the ERP software package. Thus, there is a need in the art for a centralized multi-tenant monitoring system.

### BRIEF DESCRIPTION OF THE DRAWINGS

FIG. 1 illustrates an exemplary computer system providing centralized multi-tenant monitoring according to an embodiment of the present invention.

FIG. 2 illustrates a flow diagram of a method to perform centralized multi-tenant monitoring according to an embodiment of the present invention.

FIG. 3A illustrates exemplary status codes for a customer tenant according to an embodiment of the present invention.

FIG. 3B illustrates exemplary generalized status codes for a customer tenant according to an embodiment of the present invention.

FIG. 4A illustrates exemplary status codes for a central monitoring system according to an embodiment of the present invention.

FIG. 4B illustrates exemplary status codes mapping for a central monitoring system according to an embodiment of the present invention.

FIG. 5 illustrates an exemplary hardware configuration for a computing device to implement a centralized multi-tenant monitoring system according to an embodiment of the present invention.

### DETAILED DESCRIPTION

Embodiments of the present invention provide a central monitoring system for enterprise resource planning software hosted in a plurality of customer tenants. The central monitoring system may include software instructions that when executed by a computer processor, performs a method include extracting process status data from one or more customer tenants independently, transforming the extracted process status data to generate generalized status codes according to predetermined status codes, transferring the generated generalized status codes to a central monitoring system, loading the generated generalized status codes to the central monitoring system, and transforming the generalized status codes to monitoring-specific simplified status codes.

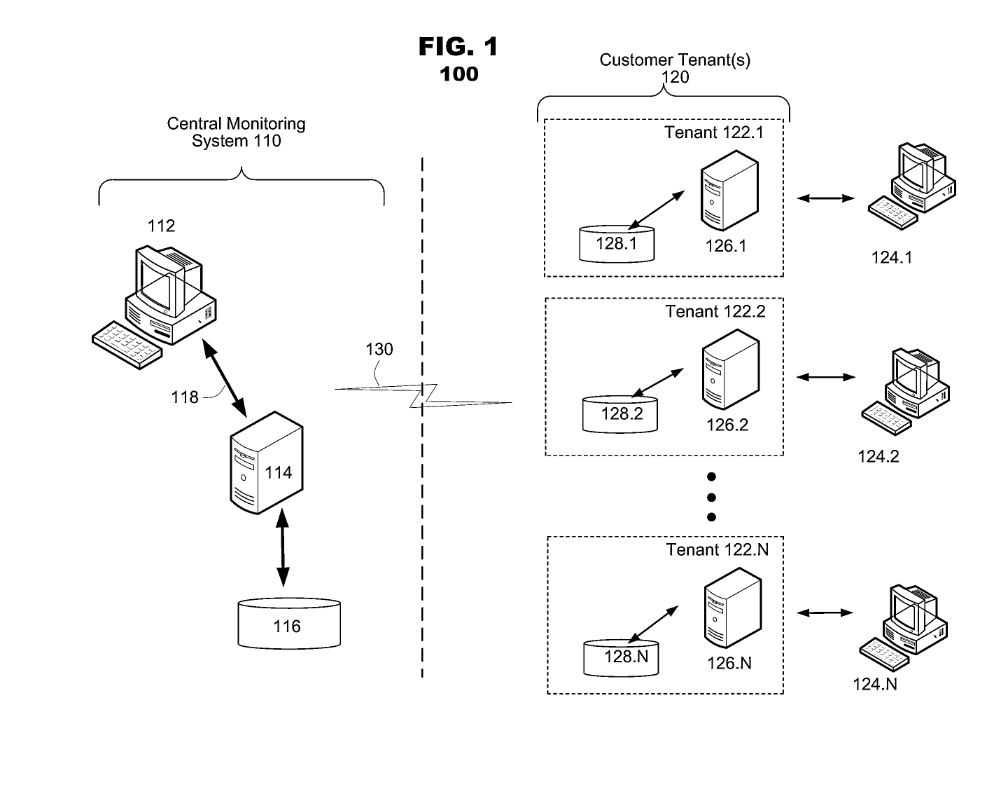

FIG. 1 illustrates an exemplary computer system 100 providing centralized multi-tenant monitoring according to an embodiment of the present invention. As illustrated in FIG. 1, the computer system 100 may include a customer tenant(s) 120 (e.g., one or more customer tenants 122.1˜122.N with N being an integer larger than one), a central monitoring system 110 and a plurality of client terminals 124 (e.g., 124.1˜124.N). Each customer tenant 122 may include an application server 126 and a data storage server 128. Each customer tenant 122 may be a virtue machine hosted by one computer server or a computer server farm (e.g., a plurality of inter-connected computer servers). That is, the plurality of application servers 126.1 through 126.N and data storage servers 128.1 through 128.N may be physically hosted by one computer server or a plurality of computer servers. Each customer tenant 122 may provide computing services to respective clients represented by the client terminals 124.

The central monitoring system 110 may comprise a server 114, a data storage 116 and a monitoring terminal 112. The central monitoring system 110 may be connected to the customer tenants via the link 130. The link 130 may be wired or wireless, and may be through an internet connection.

In an embodiment, the customer tenant(s) 102 may be hosted by an computing service provider. That is, the customer tenant(s) 102 may be hosted off site from the geographical location of the clients. Thus, the clients 124 may access the respective computing services provided by each customer tenant (e.g., 122.1˜122.N) via internet connections (secure, un-secure, remote desktops, etc.).

In an embodiment, each customer tenant 122 may provide an enterprise resource planning (ERP) system that integrates internal and external management information across an entire organization for a respective client. Each ERP system may provide computing services in a variety of business areas, such as, financials, customer relationship management, supply chain management, etc. Each business area may generate and process business data in different format and/or different content (e.g., heterogeneous business data). The business process status of all customer tenants may be gather regularly by the central monitoring system 110. The business process status may include status from the various business areas. In one embodiment, the customer tenants may run the same version of software being monitored by the central monitoring system 110.

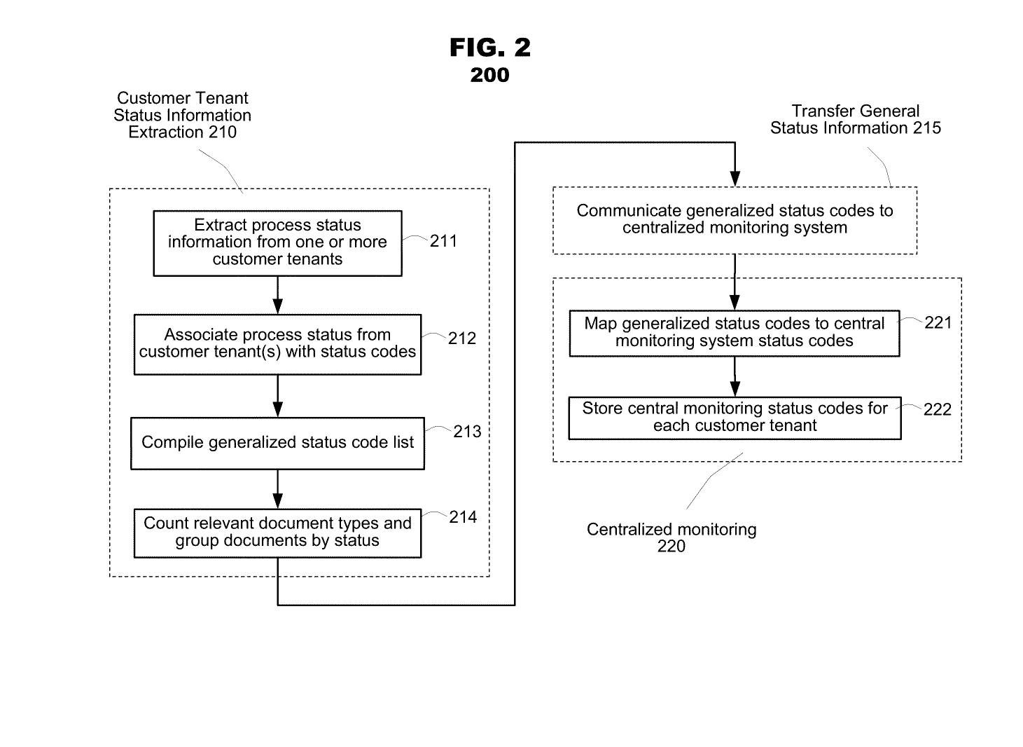

The business process status from the various business areas may be integrated into a single status model following an ETL-Approach (Extract, Transform, Load) according to one embodiment. In an embodiment, the heterogeneous business data may be extracted from the customer tenants, the extracted business data then may be transformed according to a mapping relationship to generalized status codes, and the transformed generalized status data may then be loaded into a central monitoring system. FIG. 2 illustrates a method 200 to perform centralized multi-tenant monitoring following an ETL-approch according to an embodiment of the present invention.

The method 200 may start at block 210 for customer tenant status information extraction. The customer tenant status information extraction block 210 may include a block 211 in which the heterogeneous business data (e.g., process status data) may be read from one or more customer tenants independently by a data extractor and a block 212 in which the process status data extracted from each customer tenant may be associated with predetermined status codes.

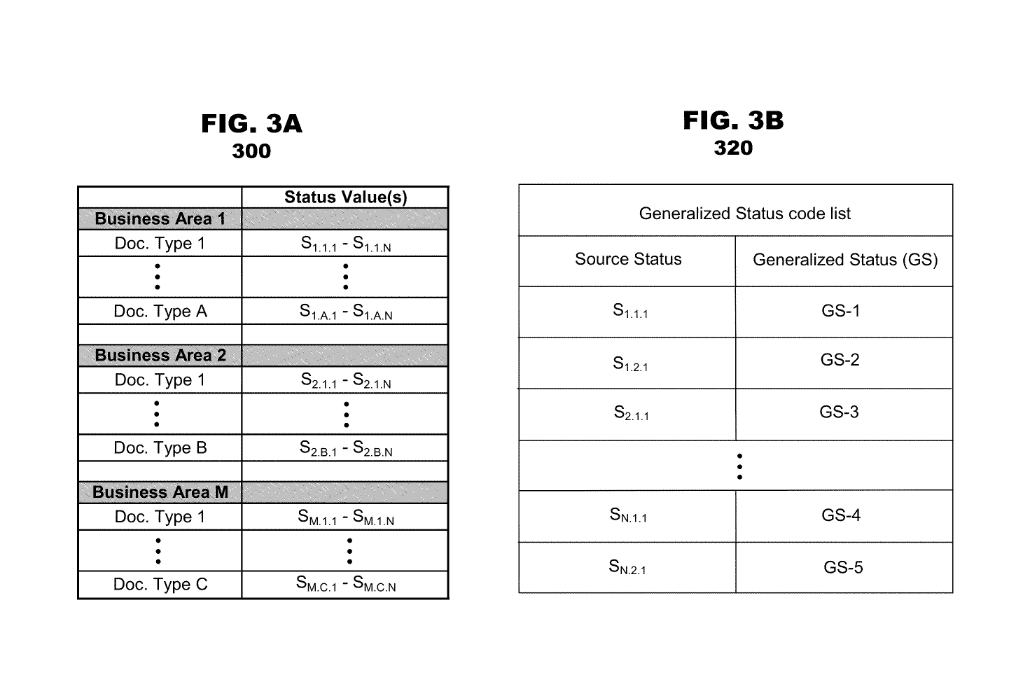

In an embodiment, the data extractor may also transform the extracted data according to a general complete status model. For example, each business area inside a customer tenant may have specific status values. For example: for Financial Documents, Document Type “Journal Entry” may have status values “In Process”, “Blocked;” and for Supplier Relationship Management (SRM), Document Type “Purchase Order” may have status values “Active”, “Cancelled.” FIG. 3A illustrates exemplary status codes for various business areas of a customer tenant according to an embodiment of the present invention. As shown in FIG. 3A, each business area may include a variety of document types and each document type may have a variety of status values. For example, the document type 1 of business area 1 may have N status values. In an embodiment, each status value may use the subscript to indicate the business area, document type and status. For example, a status code for a document type A of the business area 1 may be represented as S_{1.A.N}, in which the subscript “1.A.N” may indicate that this status code is for the business area 1, document type A, and Nth status. The status values 1˜N may indicate a document being blocked, completed, in progress, canceled, etc.

The business status from several business areas may be contained in one single table (e.g., a general table) with the status values following the model of FIG. 3A. The transformed business data may have two properties. First, the data is complete from a business process status monitoring perspective. From the status values following the model of FIG. 3A, the transformed data can be converted back into the original state completely. No monitoring relevant information is lost in the general table. Second, no sensitive customer data (e.g. Employee Names, Identifiers, Amounts, Comments or other details which a customer never wants to have published anywhere) are contained in the general table.

Referring back to FIG. 2, the customer tenant status information extraction 210 may further include a block 213 in which source status values that indicate document type, business area may be transformed to a generalized status code, and a block 214 in which relevant document types may be counted and documents may be grouped by status (e.g., number of Journal Entries in Status “Open” and number of Sales Order in Status “Active”). By counting and grouping, no customer sensitive information, such as IDs, amounts, descriptions, names, etc. are collected, and thus privacy-requirements may be met. FIG. 3B illustrates exemplary generalized status codes for a customer tenant according to an embodiment of the present invention. As shown in FIG. 3B, the source status values may be mapped to generalized codes that do not have specific details of document types or business areas. FIG. 3B shows generalized codes GS-1 through GS-5 as an example, the generalized codes may be extended to include more codes if necessary. For example, GS-6, GS-7, etc. may be added if desired. In an embodiment, each generalized code correspond to a particular status for a particular document type in a particular business area. Thus, from a transformation result generalized status code, the original process status information may be obtained completely. That is, the generalized status codes may be complete from a business process status monitoring perspective and no monitoring relevant information is lost in any transformation result generalized status codes.

In an embodiment, the block 214 may determine numbers of corresponding documents for each generalized status value per customer tenant. For example, after mapping of status codes to generalized codes of GS-1 through GS-5 are performed, the method 200 may determine, for a customer tenant, that there may be 7 documents have GS-1 status, 0 document has GS-2 status, 5 documents have GS-3 status, 12 documents have GS-4 status, and 23 documents have GS-5 status. This information may be collected regularly for each customer tenant.

After the customer tenant status information extraction block 210, the method 200 may continue to the next block 215 for communicating generalized status information to a centralized monitoring system. The generalized status information may be transferred to the central monitoring system for each monitored tenant independently. In an embodiment, existing technology, such as synchronous and/or asynchronous communication (e.g., web services) may be used. For example, the generalized status information may be collected from each of the customer tenants 120 and transferred to the central monitoring system 110 via the link 130 as shown in FIG. 1. In an embodiment, the data may be sent or pushed from each customer tenant to the central monitoring system. That way, each tenant can send data when it is able to.

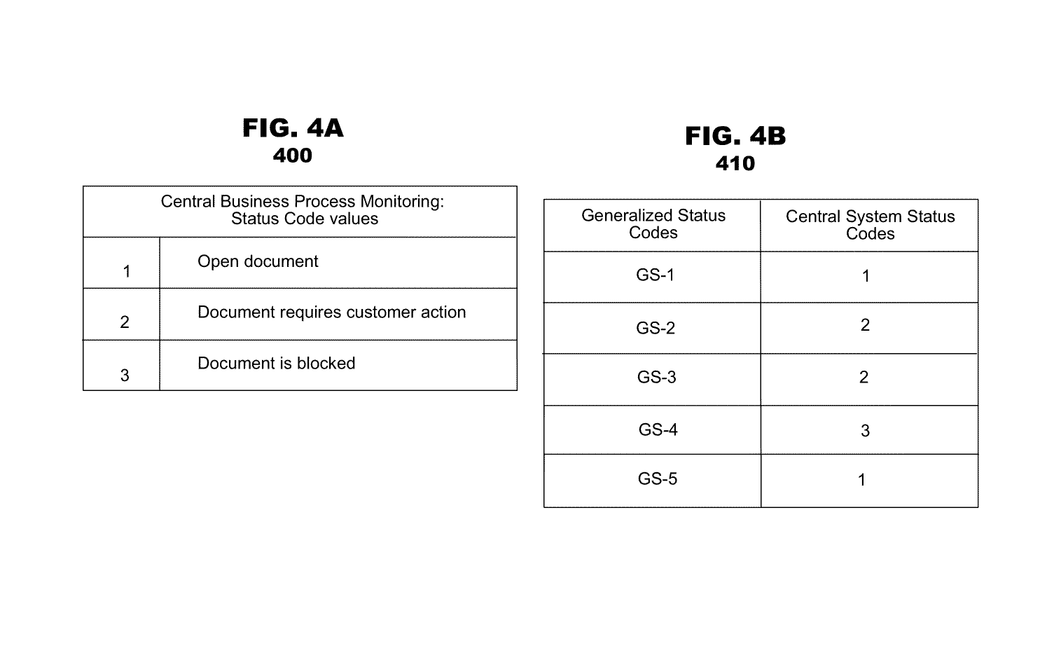

After transferring the collected data to the central monitoring system, the method 200 may load the collected data into the central monitoring system at block 220. The block 220 may include a block 221 for mapping generalized status codes to central monitoring system status codes and a block 222 for storing the central monitoring system status codes generated from the mapping. The mapping from generalized status codes to central monitoring system status codes may condense the generalized status codes according to a monitoring-specific, simplified status model. FIG. 4A illustrates exemplary central monitoring status codes 400 for a central monitoring system according to an embodiment of the present invention and FIG. 4B illustrates exemplary status codes mapping 410 from generalized status codes to a central monitoring system status codes according to an embodiment of the present invention. Because the first transformation from process status data to generalized status code is fully reversible,—no information is lost—all business process information is preserved and sent to central system. The mapping from the generalized status codes to central monitoring system status codes may be a one way data transformation and cannot be inverted. In an embodiment, in case the one set of mapping turns out to be not satisfactory, the mapping table 410 may be adjusted for “condensation” without having to change any code on the customer tenants. With the mapping, the integration of status data from completely different business areas into a single status model may be completed. At block 222, the condensed status information from various tenants may be stored in a single data base. The single data base may act as a repository for a central monitoring system (e.g., a service provider cockpit) for a large amount of customer tenants. In an embodiment, the business process status of all customers may be read regularly (e.g., daily or weekly) from various business areas and may allow implementation of follow-up processes within Application Management.

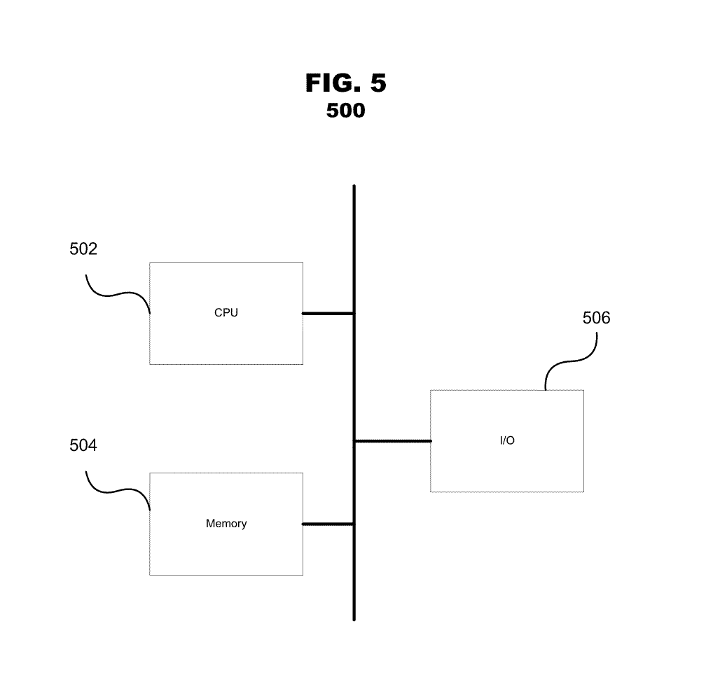

FIG. 5 illustrates an exemplary hardware configuration for implementing a computing device 500 according to an embodiment of the present invention. The computing device 500 may represent an embodiment of a server that hosts customer tenant (s) 120, the terminal 124, the server 114 and/or the monitoring terminal 112. The computing device 500 includes a processor 502, memory 504, and an I/O device(s) 506. The processor 502 is connected to the memory 504 and I/O device(s) 506. These connections are direct or via other internal electronic circuitry or components.

The processor 502 is a programmable processor that executes instructions residing in the memory 504 to receive and send data via the I/O device(s) 506. The instructions may perform the operations of a multi-tenants central monitoring process according to an exemplary embodiment. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 502 is an Intel® microprocessor.

Memory 504 is a machine-readable medium that stores data that is processed by the processor 502. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to the processor 502 via one or more I/O device(s) 506.

The I/O device(s) 506 may be one or more input/output interfaces that receive and/or send digital data to and from an external device. Interfaces as used herein are any point of access to an external device where digital data is received or sent, including ports, buffers, queues, subsets thereof, or any other interface to an external device.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

We claim:

1. A computer system, comprising:
a memory to store computer instructions; and
a processor coupled to the memory to execute the computer instructions to:
extract process status data from one or more customer tenants independently;
transform the extracted process status data to generate generalized status codes according predetermined status codes;
transfer the generated generalized status codes to a central monitoring system;
load the generated generalized status codes to the central monitoring system; and
transform the generalized status codes to monitoring-specific simplified status codes.

2. The computer system of claim 1, wherein transforming the extracted process status data to generate generalized status codes according to predetermined status codes includes counting and grouping documents with same status to ensure that privacy-requirements are met.

3. The computer system of claim 1, wherein each customer tenant includes a variety of business areas and the process status data is extracted from the variety of business areas.

4. The computer system of claim 1, wherein each customer tenant is a virtual machine hosted by a computer server or server farm.

5. The computer system of claim 4, wherein each virtual machine executes an enterprise resource planning (ERP) software for a single customer and the ERP software are the same version for all customers.

6. The computer system of claim 1, wherein transforming the generalized status codes to monitoring-specific simplified status codes is a one way transformation and cannot be inverted.

7. The computer system of claim 1, wherein the extracted process status information indicates a status for a document type and an originating business area.

8. A method, comprising:
extracting process status data from one or more customer tenants independently;
transforming the extracted process status data to generate generalized status codes according to predetermined status codes;
transferring the generated generalized status codes to a central monitoring system;
loading the generated generalized status codes to the central monitoring system; and
transforming the generalized status codes to monitoring-specific simplified status codes.

9. The method of claim 8, wherein transforming the extracted process status data to generate generalized status codes according to predetermined status codes includes counting and grouping documents with same status to ensure that privacy-requirements are met.

10. The method of claim 8, wherein each customer tenant includes a variety of business areas and the process status data is extracted from the variety of business areas.

11. The method of claim 8, wherein each customer tenant is a virtual machine hosted by a computer server or server farm.

12. The method of claim 11, wherein each virtual machine executes an enterprise resource planning (ERP) software for a single customer and the ERP software are the same version for all customers.

13. The method of claim 8, wherein transforming the generalized status codes to monitoring-specific simplified status codes is a one way transformation and cannot be inverted.

14. The method of claim 8, wherein the extracted process status information indicates a status for a document type and an originating business area.

15. A non-transitory computer readable medium storing a program causing a computer to execute a method, the method comprising:
extracting process status data from one or more customer tenants independently;
transforming the extracted process status data to generate generalized status codes according to predetermined status codes;
transferring the generated generalized status codes to a central monitoring system;
loading the generated generalized status codes to the central monitoring system; and
transforming the generalized status codes to monitoring-specific simplified status codes.

16. The non-transitory computer readable medium of claim 15, wherein transforming the extracted process status data to generate generalized status codes according to predetermined status codes includes counting and grouping documents with same status to ensure that privacy-requirements are met.

17. The non-transitory computer readable medium of claim 15, wherein each customer tenant includes a variety of business areas and the process status data is extracted from the variety of business areas.

18. The non-transitory computer readable medium of claim 15, wherein each customer tenant is a virtual machine hosted by a computer server or server farm, each virtual machine executes an enterprise resource planning (ERP) software for a single customer and the ERP software are the same version for all customers.

19. The non-transitory computer readable medium of claim 15, wherein transforming the generalized status codes to monitoring-specific simplified status codes is a one way transformation and cannot be inverted.

20. The non-transitory computer readable medium of claim 15, wherein the extracted process status information indicates a status for a document type and an originating business area.
